(19) United States
(12) Patent Application Publication
(10) Pub. No.: US 2020/0134496 A1
(43) Pub. Date: Apr. 30, 2020

(54) CLASSIFYING PARTS VIA MACHINE LEARNING

(71) Applicant: Hewlett Packard Enterprise Development LP, Houston, TX (US)

(72) Inventors: Wilfredo E Lugo Beauchamp, Aguadilla, PR (US); William J. Hawkins, Palo Alto, CA (US)

(21) Appl. No.: 16/173,599

(22) Filed: Oct. 29, 2018

(51) Int. Cl. G06N 7/00; G06N 20/00; G06K 9/62; H04L 9/06

(52) U.S. Cl. CPC G06N 7/00; H04L 9/0643; G06K 9/6267; G06N 20/00

(57) ABSTRACT

Example implementations relate to classifying parts. A computing device may comprise a processing resource; and a memory resource storing non-transitory machine-readable instructions to cause the processing resource to: receive a part description of a part; classify the part by determining a commodity of the part based on the part description using machine learning; and update attributes of the part based on the determined commodity of the classified part.

### BACKGROUND

Manufacturers can provide parts for equipment. The parts can, in some instances, be spare parts. In some examples, the parts may be replacement parts. For example, equipment may experience glitches, loss of operating efficiencies, and/or malfunctions. Spare or replacement parts can be utilized to keep equipment in working order.

Parts may be identified in different ways. For example, parts may include part descriptions, part identification numbers, part serial numbers, etc. Tracking parts can be a useful component in determining customer satisfaction/quality metrics.

### BRIEF DESCRIPTION OF THE DRAWINGS

FIG. 1 illustrates an example system consistent with the disclosure.

FIG. 2 illustrates an example part description table consistent with the disclosure.

FIG. 3 is a block diagram of an example computing device for classifying parts via machine learning consistent with the disclosure.

FIG. 4 is a block diagram of an example system consistent with the disclosure.

FIG. 5 illustrates an example method consistent with the disclosure.

### DETAILED DESCRIPTION

Tracking parts can be a useful component in determining various metrics about products and/or parts in the products. For example, tracking a rate of replacement of a particular part can be useful in identifying issues with the particular part. For instance, the particular part may be flagged as being replaced at a high rate, and the particular part may be examined to determine whether there is a manufacturing issue with the part, whether there is an issue with a supplier of the part, etc.

Some organizations having trackable parts may be large. For example, an organization may have multiple sub-organizations that may have a particular part distributed across the multiple sub-organizations. For example, the multiple sub-organizations may all utilize the particular part in various ways (e.g., manufacturing of the part, testing of the part, installation of the part, etc.) In some instances, each of the multiple sub-organizations may identify the part in different ways. For example, the multiple sub-organizations may have different part descriptions, part identification numbers, and/or part serial numbers for the same part. Accordingly, tracking the part across the multiple sub-organizations may be difficult.

In some examples, the particular part may be identified based on inputs from a team of people. For example, a team of people may identify the particular part by assigning a part description, part identification number, and/or part serial number to the particular part, among other types of part identifiers. However, different sub-organizations may utilize different teams of people which can result in different part identifications for the same particular part. Further, identifying parts manually can be a tedious and expensive task.

Differently assigned part identifications for the same part may lead to missed opportunities for quality assurance and control. For example, if the particular part is being replaced due to a manufacturing issue, the replacement rate in a first sub-organization may be below a threshold replacement rate, and the replacement rate in a second sub-organization may also be below a threshold replacement rate, indicating to the first and second sub-organizations that there are not issues, even though across the whole organization the replacement rate may be above a threshold replacement rate. Accordingly, the replacement rate may not be identified as an issue since the first and second sub-organizations are identifying the part differently. Accordingly, customer satisfaction may drop as a result of the organization being unable to identify the manufacturing issue of the part.

Classifying parts via machine learning according to the disclosure can allow for an automated and accurate way to classify parts by determining a commodity of a part and determining/updating attributes of the part using the determined commodity. According to examples of the disclosure, classifying parts via machine learning can utilize previously classified part data to setup a classification scheme to classify parts. The classified parts can be utilized to generate reporting metrics which can, in some examples, identify failure modes of parts. Classifying parts via machine learning can be utilized to leverage commodities across a large organization which may have many sub-organizations without manually tasking teams with identification of parts.

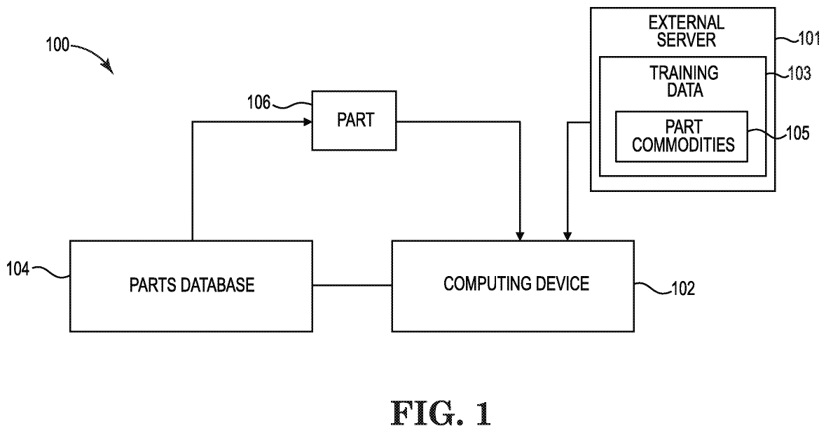

FIG. 1 illustrates an example system 100 consistent with the disclosure. As illustrated in FIG. 1, the system 100 can include computing device 102, entered parts database 104, and part 106.

System 100 can include computing device 102. As used herein, the term “computing device” can, for example, refer to a device including a processor, memory, and input/output interfaces for wired and/or wireless communication. A computing device may include a laptop computer, a desktop computer, a mobile device, and/or other wireless devices, although examples of the disclosure are not limited to such devices. A mobile device may refer to devices that are (or may be) carried and/or worn by a user. For instance, a mobile device can be a phone (e.g., a smart phone), a tablet, a personal digital assistant (PDA), smart glasses, and/or a wrist-worn device (e.g., a smart watch), among other types of mobile devices.

Computing device 102 can be utilized to classify parts. For example, computing device 102 can be utilized to classify parts, such as part 106, using machine learning, as is further described herein. As used herein, the term “machine learning” refers to a method of data analysis to identify patterns and make decisions via an analytical model. As used herein, the term “part” refers to a constituent piece of a machine. For example, part 106 can include a fan, a printed circuit board, an electrical component (e.g., resistor, capacitor, transistor, etc.), part assemblies (e.g., a power supply, a controller, a video card, etc.), among other types of parts. Additionally, parts 106 are not limited to computing device parts. For example, parts 106 can include mechanical parts, electrical parts, optical parts, etc.

As described above, classifying parts utilizing computing device 102 can be accomplished via machine learning. Accordingly, computing device 102 can train machine learning using a training data set 103. As used herein, the term “training data set” refers to a set of examples used to fit parameters of a model. For example, the training data set 103 can include previously classified parts having predetermined part commodities 105 with predetermined initial attributes. As used herein, the term “commodity” refers to a functional characteristic of an item. Commodities can include, for example, a processor commodity (e.g., if the part is a processor), a dual in-line memory module (DIMM) commodity (e.g., if the part is a DIMM), a controller commodity (e.g., if the part is a controller), a controller commodity (e.g., if the part is a controller), a fan commodity (e.g., if the part is a fan/fan assembly), an “other boards” commodity (e.g., if the part is a fan controller board), etc. As used herein, the term “attribute” refers to a characteristic or property of an item. For example, attributes can include a commodity classification, supplier, supplier location, manufacturing location, etc.

Computing device 102 can receive a training data set 103 from an external server 101. As described above, the training data set 103 can include previously classified parts having predetermined part commodities 105 with predetermined initial attributes. The parts in the training data set 103 can include manually classified parts. For instance, in some examples an organization may have a previously existing database of parts having part commodities 105 and initial attributes that have been manually determined by a person or team of persons. The training data set 103 can be utilized to train the machine learning algorithm such that computing device 102 can classify parts, as is further described herein.

As described above, a part may be a constituent piece of a machine. For example, the part may be mechanical, electrical, optical, etc. The part may be included initially as a component of machine, may be a spare part, may be a replacement part, etc. In various scenarios, a part, such as part 106, may have to be classified or reclassified, as is further described herein.

For example, part 106 may be a part utilized as a replacement part. For example, part 106 may be a fan controller that is being used as a replacement part in a computing device. As used herein, the term “replacement part” refers to a part utilized to return a machine back to a previous state of being. For example, a previous fan controller may have malfunctioned and part 106 is a replacement fan controller to restore a computing device having the fan controller to a working state. Accordingly, a technician may install part 106 for a customer and can provide information regarding part 106 to parts database 104. As used herein, the term “parts database” refers to a collection of data relating to various parts. For example, parts database 104 can be a collection of data relating to various parts for various machines. Computing device 102 may receive a part description of the part 106.

Part 106 can be classified according to examples of the disclosure as further described herein. As previously described above, part 106 can include a part description and initial attributes. In some examples, part 106 may be utilized by a first sub-organization which may have given part 106 a part description. The part description can include a description of the part and/or a part number of the part. For example, part 106 can include a factory description of “ASSY P63x0 FC CONTROLLER” and can include a factory part identification number (e.g., a part number) of “463245-001”.

However, as described above, in some examples, some organizations may be large and have multiple sub-organizations which can also utilize part 106. For example, part 106 can have a second sub-organization which may have given part 106 a different part description. For example, part 106 may include a field description of “SPS-CONTROLLER, FAN, MCS G2” and can include a field part identification number (e.g., a part number) of “468279-001”. As illustrated above, part 106 can include a part description (e.g., factory description/factory part identification number from a first sub-organization), but a different part that may be the same part as part 106 may include a different part description (e.g., field description/field part identification number e.g., from a second sub-organization). Computing device 102 can classify part 106 and the different part that may be the same part as part 106 having a different part description to update attributes of the two parts so that they are similar, as is further described herein. In some examples, part 106 may be an unclassified part. For example, part 106 may not include any attributes but include a part description. Additionally, computing device 102 can classify unclassified part 106 to update attributes of unclassified part 106, as is further described herein.

Computing device 102 can classify part 106 by determining a commodity of the part 106. The commodity of part 106 can be based on initial attributes of the part 106. Computing device 102 can classify part 106 by determining the commodity based on initial attributes of part 106 using machine learning. For example, computing device 102 can analyze data such as initial attributes of part 106 and a part description of part 106 to determine a commodity for part 106.

In some examples, computing device 102 can classify part 106 via logistic regression machine learning. As used herein, the term “logistic regression machine learning” refers to a method of machine learning used for binary classification. For example, computing device 102 can classify part 106 as in the processor commodity or not in the processor commodity, in the DIMM commodity or not in the DIMM commodity, etc.

Classification of part 106 can include generating a token for each word included in the part description of the part. As used herein, the term “token” refers to a character or string with an assigned meaning. As described above, part 106 can include a factory description of “ASSY P63x0 FC CONTROLLER”. Other descriptions of part 106 (e.g., from other sub-organizations) may include “4056 Fan R2x00 Gen 10” and/or “Fan Controller Board”. Accordingly, computing device 102 can create tokens for each word in the part description. For example, ASSY is assigned a token ID of 1, P63x0 is assigned a token ID of 2, FC is assigned a token ID of 3, CONTROLLER is assigned a token ID of 4, 4056 is assigned a token ID of 5, FAN is assigned a token ID of 6, R2x00 is assigned a token ID of 7, Gen10 is assigned a token ID of 8, and Board is assigned a token ID of 9. Accordingly, a token vector of 9 words has been created. Utilizing the 9 word token vector, the part description input can be translated into a 9 element One Hot Encoding vector of:
Part 1: [1 1 1 1 0 0 0 0 0]
Part 2: [0 0 0 0 1 1 1 1 0]
Part 3: [0 0 0 1 0 1 0 0 1]

While these vectors may be passed to the machine learning algorithm as is, a word index table stored in memory may have to be stored to keep translating all new part descriptions, where more words result in a larger size, as well as words not included in training data may be ignored. Accordingly, computing device 102 can perform a hashing step.

Computing device 102 can apply a hash function to the token for each word included in the part description of part 106 to generate an index value for each word included in the part description. As used herein, the term “hash function” refers to a function that maps data of an arbitrary size to data of a fixed size. For example, a hash function can be applied such that each word can return an integer between [0-2²⁰]. Accordingly, a hashing function can produce the same hash value for the same word. Therefore, for each word in the part description of part 106, an index value is returned and a 1 is located into the index value. Utilizing the hashing function can allow for less memory usage by computing device 102. In an instance in which a particular index value of a particular word matches an index value of another word (e.g., a hashing collision), the particular index causing the hashing collision can be advanced by 1.

Computing device 102 can apply ‘One versus Rest’ Logistic Regression' of the index value for each word included in the part description against the predetermined training data to classify part 106 to determine the commodity of part 106. The Logistic Regression can utilize a linear model and build a separate binary logistic regression model fore ach class of classification. Regularization terms (e.g., L2 (Ridge) regularization term) can be added as a weight to produce an acceptable Receiver Operating Characteristic (ROC) Multi-class Area Under the Curve (MAUC). For example, computing device 102 can apply logistic regression against the predetermined training data using the hashed vectors described above to classify part 106 in a controller commodity.

Although machine learning is described above as logistic regression machine learning, examples of the disclosure are not so limited. For example, computing device 102 can utilize other types of machine learning, including Random Forest machine learning, XGBoost machine learning, Decision Tree machine learning, and/or Artificial Neural Network machine learning, among other types of machine learning.

Computing device 102 can update attributes of part 106 based on the determined commodity of part 106 from initial attributes to revised attributes. For example, part 106 may include initial attributes include a commodity classification of a fan. Based on the part 106 being classified as a controller, computing device 102 can update attributes of part 106 to indicate the commodity classification as a controller, among other examples.

In some examples, computing device 102 can misclassify part 106. For example, part 106 may be classified as a fan assembly instead of as a controller. In such an instance, computing device 102 can modify the revised attributes of part 106 in response to the revised attributes being misclassified. For example, a user may see part 106 as being misclassified as a fan assembly and can cause computing device 102 (e.g., via a user input) to modify the revised attributes of part 106 from a fan assembly to a controller. In some instances, computing device 102 can misclassify part 106 as a result of an erroneously classified predetermined data set.

As described above, computing device 102 can classify part 106 and update attributes of part 106 so that parts database 104 can include parts having updated attributes. Different sub-organizations in an organization may include the same part as part 106 which can be classified by computing device 102 so that similar parts can include similar attributes. An organization may desire to track various parts and their characteristics across sub-organizations that may not have coordinated part naming conventions, as is further described herein.

In some examples, computing device 102 can generate a report of parts having the same determined commodity as part 106. For example, computing device 102 can utilize data stored in parts database 104 having parts classified using machine learning (e.g., as described above) and generate a report of parts having a same commodity. For instance, part 106 had a determined commodity of a controller. The report of parts having a controller commodity can be utilized to see whether the same type of controller is being replaced, it's rate of replacement, etc. Such metrics may be utilized to determine whether an issue is present with the controller. For example, in response to a rate of replacement of the controller being higher than a threshold rate, engineers may determine an issue with the controller (e.g., a manufacturing issue, an issue with the supplier of the controller, etc.) In some examples, computing device 102 can generate a report indicating a replacement rate of parts having the same commodity as part 106.

In some examples, computing device 102 can generate a report of parts having the same updated attribute as part 106. For example, computing device 102 can utilize data stored in parts database 104 having parts classified using machine learning (e.g., as described above) and generate a report of parts having same attributes. For example, part 106 can include attributes such as where the part 106 was shipped from, which factory the part 106 was shipped from, where the factory is located, where the part 106 was manufactured, where part 106 was shipped to, etc. Such metrics may be utilized across parts having same attributes to determine how many parts are manufactured in the particular location, how many parts are used at a particular site where part 106 was shipped to, etc.

Classifying parts via machine learning according to the disclosure can allow for an automated way to classify parts for use across an organization by utilizing previously classified part data. Classifying parts can be utilized to determine various metrics such as where parts are being shipped to/from, replacement rates of parts, etc. These metrics may be utilized to determine issues with parts across organizations which may have different description schemes without manually tasking teams with identification of parts.

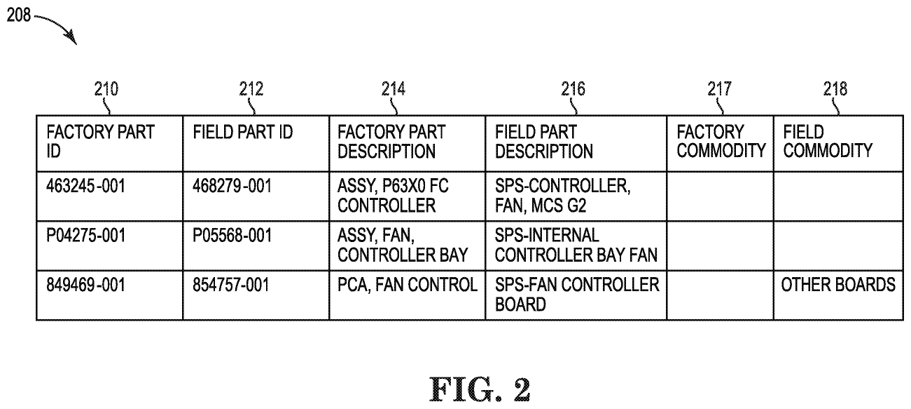

FIG. 2 illustrates an example part description table 208 consistent with the disclosure. As illustrated in FIG. 2, part description table 208 includes factory part IDs 210, field part IDs 212, factory part descriptions 214, field part descriptions 216, factory commodities 217, and field commodities 218.

Part description table 208 includes different naming conventions across different sub-organizations of particular parts. For example, the first row can include a factory part description 214 (e.g., ASSY, P63x0 FC CONTROLLER) that can differ from the field part description 216 (e.g., SPS-CONTROLLER, FAN, MCS G2). These differences can illustrate the different naming conventions certain sub-organizations may employ across an entire organization for a particular part, even when the particular part is the same part used across the sub-organizations. Further, the part does not include a commodity classification from either sub-organization (e.g., factory 217, field 218). Classifying parts via machine learning, according to the disclosure, can utilize these naming conventions to classify parts using machine learning, as is described in connection with FIG. 1.

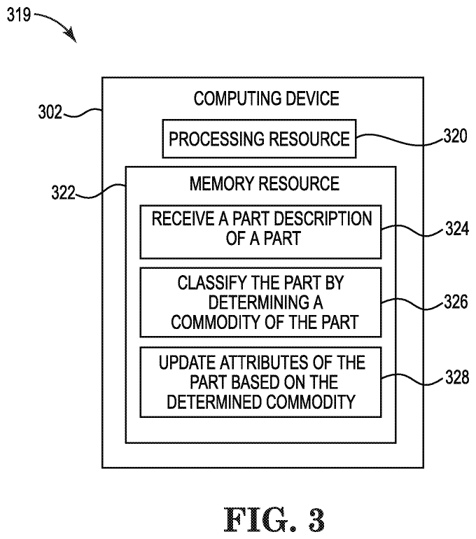

FIG. 3 is a block diagram 319 of an example computing device 302 for classifying parts via machine learning consistent with the disclosure. As described herein, the computing device 302 may perform a number of functions related to classifying parts. Although not illustrated in FIG. 3, the computing device 302 may include a processor and a machine-readable storage medium. Although the following descriptions refer to a single processor and a single machine-readable storage medium, the descriptions may also apply to a system with multiple processors and multiple machine-readable storage mediums. In such examples, the computing device 302 may be distributed across multiple machine-readable storage mediums and the computing device 302 may be distributed across multiple processors. Put another way, the instructions executed by the computing device 302 may be stored across multiple machine-readable storage mediums and executed across multiple processors, such as in a distributed or virtual computing environment.

As illustrated in FIG. 3, the computing device 302 may comprise a processing resource 320, and a memory resource 322 storing machine-readable instructions to cause the processing resource 320 to perform a number of operations relating to classifying parts. That is, using the processing resource 320 and the memory resource 322, the computing device 302 may classify a part and update attributes of the part based on a determined commodity of the part, among other operations. Processing resource 320 may be a central processing unit (CPU), microprocessor, and/or other hardware device suitable for retrieval and execution of instructions stored in memory resource 322.

The computing device 302 may include instructions 324 stored in the memory resource 322 and executable by the processing resource 320 to receive a description of a part. The part description can be received from a database. For example, a part may be replaced in the field, and the part may include a part description. The part description may be pre-assigned (e.g., by the manufacturer, by the receiving company, by the installer, etc.)

The computing device 302 may include instructions 326 stored in the memory resource 322 and executable by the processing resource 320 to classify the part by determining a commodity of the part. Computing device 302 can classify the part by applying machine learning against a tokenized/hashed part description to determine a commodity of the part. For example, computing device 302 can classify the part by determining the part is a DIMM belonging in a DIMM commodity.

The computing device 302 may include instructions 328 stored in the memory resource 322 and executable by the processing resource 320 update attributes of the part based on the determined commodity of the classified part. For example, computing device 302 can update attributes such as commodity classification, supplier, supplier location, manufacturing location, among other types of attributes, as previously described in connection with FIG. 1.

In this manner, the computing device 302 can classify a part by determining a commodity of the part and updating attributes of the part. Using classified parts can help track parts by an organization across different sub-organizations which may use the same part but have different naming conventions for the part.

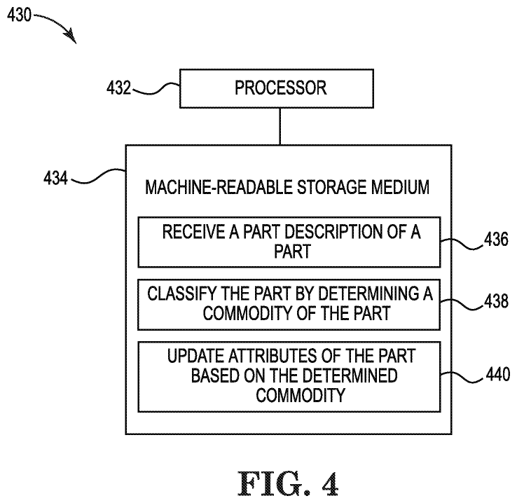

FIG. 4 is a block diagram of an example system 430 consistent with the disclosure. In the example of FIG. 4, system 430 includes a processor 432 and a machine-readable storage medium 434. Although the following descriptions refer to a single processor and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processor 432 may be a central processing unit (CPU), microprocessor, and/or other hardware device suitable for retrieval and execution of instructions stored in machine-readable storage medium 434. In the particular example shown in FIG. 4, processor 432 may receive, determine, and send instructions 436, 438, and 440. As an alternative or in addition to retrieving and executing instructions, processor 432 may include an electronic circuit comprising a number of electronic components for performing the operations of the instructions in machine-readable storage medium 434. With respect to the executable instruction representations or boxes described and shown herein, it should be understood that part or all of the executable instructions and/or electronic circuits included within one box may be included in a different box shown in the figures or in a different box not shown.

Machine-readable storage medium 434 may be any electronic, magnetic, optical, or other physical storage device that stores executable instructions. Thus, machine-readable storage medium 434 may be, for example, Random Access Memory (RAM), an Electrically-Erasable Programmable Read-Only Memory (EEPROM), a storage drive, an optical disc, and the like. The executable instructions may be “installed” on the system 430 illustrated in FIG. 4. Machine-readable storage medium 434 may be a portable, external or remote storage medium, for example, that allows the system 430 to download the instructions from the portable/external/remote storage medium. In this situation, the executable instructions may be part of an “installation package”. As described herein, machine-readable storage medium 434 may be encoded with executable instructions for classifying parts.

Receive instructions 436, when executed by a processor such as processor 432, may cause system 430 to receive a part description of a part. The part description of the part can include initial attributes of the part. The part description can be received from a database. For example, a part may be replaced in the field, and the part may include a part description. The part description may be pre-assigned (e.g., by the manufacturer, by the receiving company, by the installer, etc.)

Classify instructions 438, when executed by a processor such as processor 432, may cause system 430 to classify the part by determining a commodity of the part. The part can be classified determining the commodity of the part based on the part description of the part using machine learning. For example, the part can be classified using logistic regression machine learning.

Update instructions 440, when executed by a processor such as processor 432, may cause system 430 to update attributes of the part based on the determined commodity of the classified part. The attributes can be updated from the initial attributes to revised attributes. For example, attributes such as commodity classification, supplier, supplier location, manufacturing location, among other types of attributes can be updated.

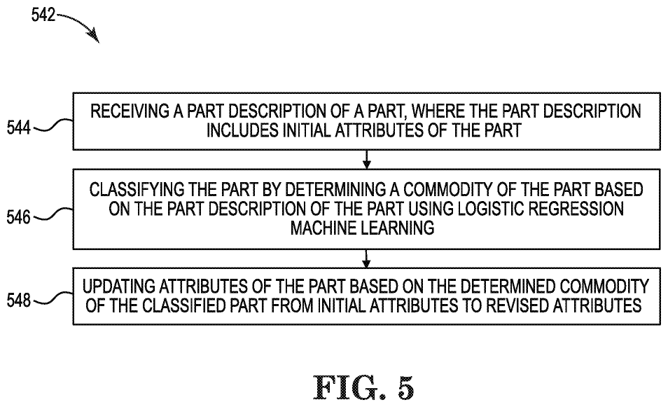

FIG. 5 illustrates an example method 542 consistent with the disclosure. Method 542 may be performed, for example, by a computing device (e.g., computing device 102, 302, previously described in connection with FIGS. 1 and 3, respectively).

The method 542 can include training a logistic regression machine learning algorithm. The logistic regression machine learning algorithm can be trained by utilizing a training data set having parts including predetermined initial attributes. The training data set can include parts which have been manually classified. For instance, in some examples an organization may have a previously existing database of parts having part commodities and initial attributes that have been manually determined by a person or team of persons.

At 544, the method 542 includes receiving a part description of a part. The part description can be received by a computing device. The part description can include initial attributes of the part. The part description can be received from a database. For example, a part may be replaced in the field, and the part may include a part description. The part description may be pre-assigned (e.g., by the manufacturer, by the receiving company, by the installer, etc.)

At 546, the method 542 includes classifying, by the computing device, the part by determining a commodity of the part based on the part description of the part. The computing device can classify the part using logistic regression machine learning. However, examples of the disclosure are not limited to logistic regression machine learning. For example, the computing device can classify the part using other machine learning techniques, such as Random Forest machine learning, XGBoost machine learning, Decision Tree machine learning, and/or Artificial Neural Network machine learning, etc.

At 548, the method 542 includes updating, by the computing device, attributes of the part based on the determined commodity of the classified part. The computing device can update attributes from the initial attributes to revised attributes. For example, attributes such as commodity classification, supplier, supplier location, manufacturing location, among other types of attributes can be updated.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Similar elements or components between different figures may be identified by the use of similar digits. For example, 102 may reference element “02” in FIG. 1, and a similar element may be referenced as 302 in FIG. 3. Elements shown in the various figures herein can be added, exchanged, and/or eliminated so as to provide a plurality of additional examples of the present disclosure. In addition, the proportion and the relative scale of the elements provided in the figures are intended to illustrate the examples of the present disclosure and should not be taken in a limiting sense.

What is claimed:

1. A computing device, comprising:
a processing resource; and
a memory resource storing non-transitory machine-readable instructions to cause the processing resource to:
receive a part description of a part;
classify the part by determining a commodity of the part based on the part description using machine learning; and
update attributes of the part based on the determined commodity of the classified part.

2. The computing device of claim 1, including instructions to cause the processing resource to classify the part using logistic regression machine learning.

3. The computing device of claim 1, including instructions to cause the processing resource to train the machine learning using a training data set.

4. The computing device of claim 3, wherein the training data set includes a plurality of parts each including predetermined part commodities having parts including predetermined initial attributes.

5. The computing device of claim 1, including instructions to cause the processing resource to generate a report of parts having the same determined commodity of the classified part.

6. The computing device of claim 1, including instructions to cause the processing resource to generate a report of parts having a same updated attribute of the classified part.

7. The computing device of claim 1, wherein the part description of the part includes at least one of:
a description of the part; and
a part number of the part.

8. The computing device of claim 1, wherein the part is a replacement part.

9. The computing device of claim 1, wherein the part is an unclassified part.

10. The computing device of claim 1, including instructions to cause the processing resource to modify the updated attributes of the part in response to a user input.

11. A non-transitory computer readable medium storing instructions executable by a processing resource to cause the processing resource to:
receive a part description of a part, wherein the part description includes initial attributes of the part;
classify the part by determining a commodity of the part based on the part description of the part using machine learning; and
update attributes of the part based on the determined commodity of the classified part from initial attributes to revised attributes.

12. The medium of claim 11, wherein the instructions to classify the part include instructions to generate a token for each word included in the part description of the part.

13. The medium of claim 12, wherein the instructions to classify the part include instructions to apply a hash function to the token for each word included in the part description of the part to generate an index value for each word included in the part description.

14. The medium of claim 13, including instructions to use one versus rest logistic regression machine learning of the index value for each word included in the part description against predetermined training data to classify the part to determine the commodity of the part.

15. The medium of claim 13, including instructions to advance a particular index value of a particular word included in the part description by one in response to the particular index value of the particular word matching an index value of a different word.

16. A method, comprising:
receiving, by a computing device, a part description of a part, wherein the part description includes initial attributes of the part;
classifying, by the computing device, the part by determining a commodity of the part based on the part description of the part using logistic regression machine learning; and
updating, by the computing device, attributes of the part based on the determined commodity of the classified part from initial attributes to revised attributes.

17. The method of claim 16, wherein the method includes modifying, by the computing device, the revised attributes of the part in response to the revised attributes being misclassified.

18. The method of claim 16, wherein the method includes training the logistic regression machine learning utilizing a training data set having parts including predetermined initial attributes.

19. The method of claim 18, wherein the method includes receiving, by the computing device, the training data set from an external server.

20. The method of claim 16, wherein the method includes generating, by the computing device, a report including a replacement rate of parts having the same determined commodity of the classified part.
